(19) United States
(12) Patent Application Publication
(10) Pub. No.: US 2016/0283659 A1
(43) Pub. Date: Sep. 29, 2016

(54) OPERATION OF A MEDICAL IMAGING DEVICE

(71) Applicants: David Grodzki, Erlangen (DE); Björn Heismann, Erlangen (DE)

(72) Inventors: David Grodzki, Erlangen (DE); Björn Heismann, Erlangen (DE)

(21) Appl. No.: 15/070,112

(22) Filed: Mar. 15, 2016

(30) Foreign Application Priority Data
Mar. 26, 2015 (DE) 102015205493.4

(51) Int. Cl. G06F 19/00

(52) U.S. Cl. CPC G06F 19/321; G06F 19/3443

(57) ABSTRACT

The embodiments relate to a method for operation of a medical imaging device and a medical imaging device, a contrast medium administration unit and a computer program product. According to the method, a clinical request is provided, on the basis of which operating information is determined for the medical imaging device by a computer unit. An indication-driven at least partially automated conversion of information is proposed, in particular, a conversion of referral requests into an imaging procedure, and conversely, an adaptation of the imaging results to expectations of the referrer.

This application claims the benefit of DE 10 2015 205 493.4, filed on Mar. 26, 2015, which is hereby incorporated by reference in its entirety.

### TECHNICAL FIELD

The embodiments relate to a method for operation of a medical imaging device, a medical imaging device, a contrast medium administration unit, and a computer program product.

### BACKGROUND

The importance of medical imaging is growing constantly since it offers many possibilities for the pictorial representation of an object under investigation, in particular a human or animal body. Depending on the medical problem, a suitable imaging process may be carried out by which one or more images with the greatest possible diagnostic value are generated. Imaging methods may include radiography, computed tomography (CT), magnetic resonance tomography (MRT), positron emission tomography (PET), and sonography (ultrasound).

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the present embodiments to provide a method, devices, and a computer program product that enable improved operation of medical imaging devices.

Thus, according to the method for operation of a medical imaging device, a clinical request is provided, on the basis of which operating information for the medical imaging device is determined by a computer unit.

The clinical request may classify and/or categorize an examination problem, so that it is particularly suitable for deriving therefrom a, particularly unambiguous, item of operating information. The clinical request may include, for example, a diagnostic standard and/or a diagnosis code and/or an ICD code (International Statistical Classification of Diseases and Related Health Problems), for example, ICD-10 code G31.0.

The operating information may include information that relates to and/or specifies a manner of carrying out the imaging process of a medical issue, in particular a method and manner of scan data acquisition and/or a processing and/or representation and/or presentation of any acquired scan data and/or the influencing of an examination object before and/or during a scan. Influencing of the examination object possibly affects the scan data recorded, although it may not be necessary in order to generate the scan data. The medical issue may be specified and/or defined by the clinical request that is provided. In other words, from the clinical request may be derived what is to be investigated, how it is to be investigated and how an investigation result is to be presented.

Advantageously, the provision of the clinical request is made in electronic form so that it may be processed by the computer unit that may include an artificial intelligence. Since the determination of the operating information is carried out by the computer unit, this act may take place fully or partly automatically. With fully automatic determination, at least one operating parameter of the medical imaging device may be stipulated without the intervention of any operating personnel. In this way, the cost-effectiveness and reproducibility of medical imaging devices may be increased. In the case of partly automated preparation, it is conceivable that any operating personnel intervene manually in the determination of the operating information, perhaps by data input. For example, it is conceivable that through this manual intervention, patient-specific examination parameters are optimized. In this way, the flexibility of operation of the medical imaging device may be increased.

Through this type of determination of operating information for the medical imaging device, an imaging examination and particularly the results thereof may be standardized, so that the economical utilization of the medical imaging device may be enhanced. Furthermore, by the method described, any operating personnel may be dispensed with and/or the demands made on any operating personnel may be reduced, for example, less qualified or trained medical technical assistants (MTAs) are needed for operating the medical imaging device, and this is advantageous particularly in emergent economies and in rural areas. But also in areas without specifically trained staff such as MTAs and/or radiologists, the use of medical imaging devices may be simplified, for example, at the point of care, by dentists, general practitioners, surgeons, in neonatal stations, etc.

In one embodiment, in an additional act, the clinical request is determined on the basis of a requisition.

The requisition may present a description of the medical problem. The requisition may be contained, for example, in a referral. The requisition may be available in electronic form and/or in paper form. Specifically, in hospitals, referrals for inpatients are often registered digitally in the electronic hospital and radiological information system that may be accessed to determine the clinical requirements. Communication of the requisition by a written referral often takes place, for example, in medical practices and in small hospitals in emergent economies. Digital referrals may also be generated externally, for example, outside the hospital or the practice in which the medical imaging device is operated, and/or may be transmitted, for example, via the internet and/or on the basis of a health insurance card of the patient.

Exemplary requisitions are referral texts such as “patient has headache/dizziness, raised blood markers, exclude tumor” or “suspected Alzheimer's, exclude vascular dementia”. However, these are often drawn up in an individual and/or free-form and non-standardized way by an issuer, particularly by a prescribing physician. In particular, given a medical question with the same content, the syntax and/or vocabulary and/or choice of words and/or formulation of the requisition may vary from requisition to requisition.

Therefore, through the determination of the clinical request on the basis of a requisition, an often freely formulated text is converted into a normalized and/or standardized and/or classified medical specification particularly suited to processing by the computer unit. However, it is also conceivable that the requisition, that is, for example, a referral text, is already identical in content to the clinical request, e.g., the determination of the clinical request from the requisition may represent an identical formulation.

Advantageously, this act of the conversion of the requisition into a clinical request is also supported by a computer unit so that it may also be carried out fully or partially automatically.

The determination of the requisition may include an acquisition of an item of text and/or image information by an acquisition unit. The acquisition unit may be an optical acquisition device, for example, a scanner and/or a reading device and/or a camera, or a device for receiving and/or exchanging electronic and/or digital data, such as a modem and/or an electronic inbox. By the acquisition unit, for example, the text information and/or image information may be converted into electronic data that may be further processed, for example, with text recognition and/or image recognition software. In this way, any information that might be present initially only in paper form, for example, a written referral by a referring physician, may be brought into a format that permits simple further electronic processing.

This format is advantageous in a particularly embodiment in which the determination of the clinical request includes an adjustment of the requisition with a request database. The request database may be an electronic database that has a plurality of entries and is connected to the computer unit. For example, the request database may include entries that enable an association of letters and/or words and/or word groups to a clinical request. If, for example, a requisition contains the word “ear”, this may be an indication that the clinical request involves a code from chapter VIII of the ICD-10 classification system, e.g., in the request database, “ear” may be linked to the corresponding codes. It is also conceivable that when the clinical request is determined, methods of artificial intelligence are put to use.

One embodiment provides that the operating information includes at least one scan parameter. The at least one scan parameter may be a setting value of the medical imaging device, e.g., it may be specified on the basis of the at least one scan parameter how the scan data acquisition is to take place. Depending on the modality, this may relate to different parameters, for example, in a sonography, a frequency of ultrasonic waves that are to be fed into an examination object for the purpose of imaging or into a field of view (FoV) in magnetic resonance tomography.

By the support of the determination of the at least one scan parameter by the computer unit, the risk that suboptimal scan parameters are used may be reduced. Thus, for example, in clinically less developed imaging markets, clinical processes and the training of the radiologists is not always up-to-date, in a medical context. Even if exemplary methods are described in guidelines and medical publications, this knowledge is often not available to the radiologist and/or an operator, for example an MTA. This possible deficit may be counteracted with the method, for example, by the use of artificial intelligence that may make use of a broad knowledge base.

In a further act of the method, on the basis of the at least one scan parameter, scan data is acquired by the medical imaging device. Since the at least one scan parameter used results from an optimized determination by the computer unit on the basis of the clinical request made, the scan data acquired also may have a high quality and is therefore, for example, particularly suitable for diagnostic purposes.

In one embodiment, the determination of the operating information includes a comparison of the clinical request with an operating information database. The operating information database may be an electronic database that has a plurality of entries and is connected to the computer unit. The computer unit is advantageously capable of comparing the clinical request with the entries of the operating information database and of generating operating information therefrom. The at least one scan parameter, inter alia, may be stored in the operating information database.

A variant of the method provides that in order to determine the at least one scan parameter, from a plurality of scan protocols, one scan protocol is selected. Depending on the modality used, a scan protocol may have a different content. For example, a scan protocol of a magnetic resonance device may include one or more pulse sequences. The plurality of scan protocols may be stored, for example, in the operating information database. The selected scan protocol is advantageously a recommended standard protocol in the country and/or institution in which the medical imaging device is operated. For this reason, the knowledge of a standard and/or a guideline among less well-resourced operators remains uncertain.

The selection of the protocol may take place on the basis of different algorithms, for example by a table selection. In a large number of boundary conditions, optimization algorithms may be used for the selection of optimum scan strategies. From this, a plurality of possibilities may result that may be offered to a user.

Furthermore, it is proposed that the operating information includes at least one application parameter. The at least one application parameter may include one or more values that relate to and/or characterize an application that may be carried out in the context of the imaging method. This application may serve, in particular, to influence the examination object and may be carried out by a device. The at least one application parameter may naturally also be determined with the aid of the operating information database.

For example, the at least one application parameter may be a property of a contrast medium, in particular a type of contrast medium and/or a dosage of the contrast medium and/or an influx speed of the contrast medium and/or an administration time point of the contrast medium, etc. By the automation, the risk that the contrast medium dose is wrongly calculated and/or that a wrong contrast medium is used, for example due to human error, may be reduced.

Contrast media may improve a representation of structures and/or functions of an examination object in imaging methods. The effect of contrast media may lie therein that a signal registered in the respective examination is modified with the aim of obtaining additional information during the examination. For example, contrast media for MRT examinations may contain the chemical element gadolinium, by which surrounding protons relax more rapidly. This may significantly increase contrast differences between different tissues in an MRT scan.

In other words, an indication-driven at least partially automated conversion of information is proposed, in particular a conversion of referral requests into an imaging procedure. Furthermore, in the following, in particular in a further aspect, it is proposed that conversely, an adaptation of the imaging results to the expectations of the referrer takes place.

In one embodiment, the operating information includes a processing instruction. A processing instruction may include one or more stipulations specifying in which representation manner possibly acquired scan data is processed. The representation manner may relate, for example, to the form and/or content and/or compilation of a possible diagnostic establishment of results.

In particular, the processing instruction may include stipulations for a selection and/or scaling of one or more images to be created. The operation of the imaging device is supported in that the expressiveness of the possible diagnostic establishment of results is optimized. For example, from the clinical request ICD-10-code G31.0, it may be deduced that for the image to be created, a frontal region is to be selected and represented in an enlarged scale.

In particular, in order to determine the processing instruction, the computer unit may also access the optional operating information database in which the stipulations as to how the processing may be implemented, depending on the clinical request, may be stored.

Furthermore, the processing instruction may include stipulations on additional information to be displayed of one or more images to be created. For example, the processing instruction may stipulate that suitable legends and/or explanations relating to imaging parameters, for example contrast levels in the MRT, may be displayed. It is conceivable, in particular, that the additional information includes, in particular, country-specific information necessary to verify the imaging investigation, for example to fulfill any existing guidelines.

Advantageously, in an additional act, the acquired scan data is processed on the basis of the processing instruction. The processed scan data may advantageously be evaluated by a referring physician who may have created the requisition, in particular a referral to carry out an imaging examination, and thereby has instigated the imaging examination.

Any image data and/or images resulting from this imaging examination are therefore readily intelligible and/or meaningfully assembled for the referring physician. It may thereby be prevented that the referring physician is able to interpret the image data and/or images only in a rudimentary way or not at all.

It is also proposed that the determination of the operating information takes place dependent on at least one secondary parameter, e.g., in addition to the clinical request, the at least one secondary parameter may influence the determination of the operating information. The secondary parameter may be, for example, a country and/or an institution standard and/or a measurement time stipulation and/or at least one item of referrer information, but also a patient-specific feature such as, for example, age, height, weight, sex, any allergies, etc. This is useful in particular for a determination of any application parameters, for example a contrast medium dose.

Apart from the clinical request, further boundary conditions may also be included in the determination of the operating information. The at least one secondary parameter may be provided, for example, by a hospital information system and/or a radiological information system.

The referrer information may be, for example, a specialism of the referring physician, for example surgery, orthopedics, neurology, oncology, cardiology and/or psychiatry. Since, for different specialisms, different medical questions are often of importance, the optimum manner of recording and/or representing imaging data may be differently emphasized. As a result, this is taken into account in a possible determination of the at least one scan parameter and/or the processing instruction. It is conceivable, for example, that for a surgeon or an orthopedic specialist, other, particularly additional representations, for example volumetric 3-D reconstructions, are useful as compared with a physician from another specialism.

The method therefore enables the referrer to receive information according to need on the imaging method ordered by him, so that the understanding by the referrer of the diagnostic results may also be enhanced.

A further embodiment provides that in a further act, at least one part of the operating information is provided to an operator by an output unit, in particular a screen. For example, an automatically selected scan protocol of a magnetic resonance device is presented to the operator. Thus, the operator has the possibility of at least partially controlling the operating information determined by the computer unit and possibly of starting a measured value recording.

It is also conceivable that the operating information provided to the operator may be altered by the operator by an input unit, in particular a keyboard and/or a computer mouse and/or a touch-sensitive screen. In this way, it is made possible for the operator to adjust the operating information as desired before a scan data recording wherein a contrast medium administration possibly also takes place and/or a preparation of scan data. For example, the operator may optimize a scan protocol proposed by the computer unit and/or adjust labels of an evaluation display.

A medical imaging device and a contrast medium administration unit are described herein. The advantages thereof substantially correspond to the advantages of the method for operation of a medical imaging device, as described in detail above. The corresponding functional features of the method are herein configured by suitable modules as contained herein, in particular hardware modules.

The medical imaging device is configured to carry out a method described herein, wherein the device includes a computer unit for determining operating information on the basis of a clinical request provided.

In an extended variant, the medical imaging device includes a contrast medium injector and/or an interface to a contrast medium injector.

The contrast medium administration unit includes a contrast medium injector and a computer unit for determining an item of operating information on the basis of a clinical request provided.

Furthermore, a computer program product includes a program and is directly loadable into a memory store of a programmable system control unit of a medical imaging device and includes a program, for example libraries and auxiliary functions, in order to carry out a method when the computer program product is executed in the system control unit of the medical imaging device.

The computer program product may include an item of software with a source code that is to be compiled and linked or is only to be interpreted, or an executable software code that, for execution, is only to be loaded into the system control unit. By the computer program product, the method may be carried out rapidly, exactly reproducibly, and robustly. The computer program product is configured so that it may carry out the method acts by the system control unit. The system control unit includes the pre-conditions in each case such as, for example, a suitable working memory store, a suitable graphics card or a suitable logic unit so that the respective method acts may be carried out efficiently. The computer program product is stored, for example, on a computer-readable medium or is deposited on a network or server from where it may be loaded into the processor of a local system control unit that may be directly connected to the medical imaging device or configured as part of the medical imaging device. Furthermore, control information of the computer program product may be stored on an electronically readable data storage medium. The items of control information of the electronically readable data storage medium may be configured so that they carry out a method when the data storage medium is used in a system control unit of a medical imaging device. Examples of electronically readable data storage media are a DVD, a magnetic tape or a USB stick, on which electronically readable control information, in particular software, is stored. If this control information is read from the data storage medium and stored in a system control unit of the medical imaging device, all the embodiments of the above-described methods may be carried out. The embodiments may therefore also start from the aforementioned computer-readable medium and/or the aforementioned electronically readable data storage medium.

### BRIEF DESCRIPTION OF THE DRAWINGS

Further advantages, features and details are disclosed in the following description of exemplary embodiments and the drawings. Parts which correspond to one another are provided with the same reference signs in all the drawings.

FIG. 1 depicts a schematic representation of an example of a magnetic resonance device.

FIG. 2 depicts an example of a method in a schematic block diagram.

FIG. 3 depicts an example of an extension of the method in a schematic block diagram.

FIG. 4 depicts an example of a contrast medium administration unit.

### DETAILED DESCRIPTION

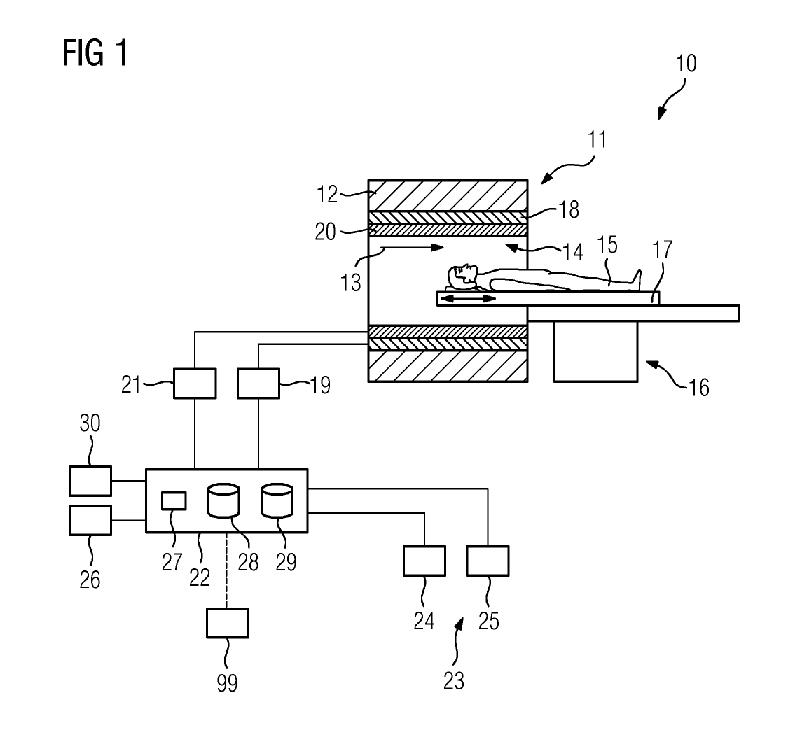

FIG. 1 depicts schematically, by way of example for a medical imaging device, a magnetic resonance device 10 configured to carry out a method for operation of a medical imaging device. The magnetic resonance device 10 has a magnet unit 11 that includes a superconducting main magnet 12 for generating a strong and, particularly, temporally constant main magnetic field 13. In addition, the magnetic resonance device 10 has a patient accommodating region 14 to accommodate a patient 15. In the present exemplary embodiment, the patient accommodating region 14 is configured cylindrical and is surrounded cylindrically in a peripheral direction by the magnet unit 11. In principle, however, a configuration of the patient accommodating region 14 deviating therefrom is readily conceivable. The patient 15 may be pushed by a patient support apparatus 16 of the magnetic resonance device 10 into the patient accommodating region 14. For this purpose, the patient support apparatus 16 has a patient table 17 configured to be movable within the patient accommodating region 14.

The magnet unit 11 also has a gradient coil unit 18 for generating magnetic field gradients that are used for position encoding during imaging. The gradient coil unit 18 is controlled by a gradient control unit 19 of the magnetic resonance device 10 and includes a plurality of gradient coils that are controlled by coil channels. The magnet unit 11 further includes a high frequency antenna unit 20 configured in the present exemplary embodiment as a body coil firmly integrated into the magnetic resonance device 10. The high frequency antenna unit 20 is configured to excite atomic nuclei in the main magnetic field 13 generated by the main magnet 12. The high frequency antenna unit 20 is controlled by a high frequency antenna control unit 21 of the magnetic resonance device 10 and radiates HF pulses into an examination space substantially formed by a patient accommodating region 14 of the magnetic resonance device 10. The high frequency antenna unit 20 is also configured for receiving magnetic resonance signals.

For controlling the main magnet 12, the gradient control unit 19 and for controlling the high frequency antenna control unit 21, the magnetic resonance device 10 has a system control unit 22. The system control unit 22 centrally controls the magnetic resonance device 10, for example, the execution of a pre-determined imaging pulse sequence. In addition, the system control unit 22 includes a storage unit. Furthermore, the magnetic resonance device 10 includes a user interface 23 connected to the system control unit 22. Control information such as, for example, imaging parameters and reconstructed magnetic resonance images may be displayed on a display unit 24, for example on at least one monitor, of the user interface 23 for medical operating personnel. In addition, the user interface 23 has an input unit 25 by which information and/or parameters may be input by the medical operating personnel during a scanning procedure.

Optionally, the magnetic resonance device 10 includes a contrast medium injector 30 and/or an interface to a contrast medium injector. This is linked to the system control unit 22 and may be controlled thereby. Furthermore, the system control unit 22 may be linked to a hospital and/or radiology information system 99, in particular wirelessly and/or by cable.

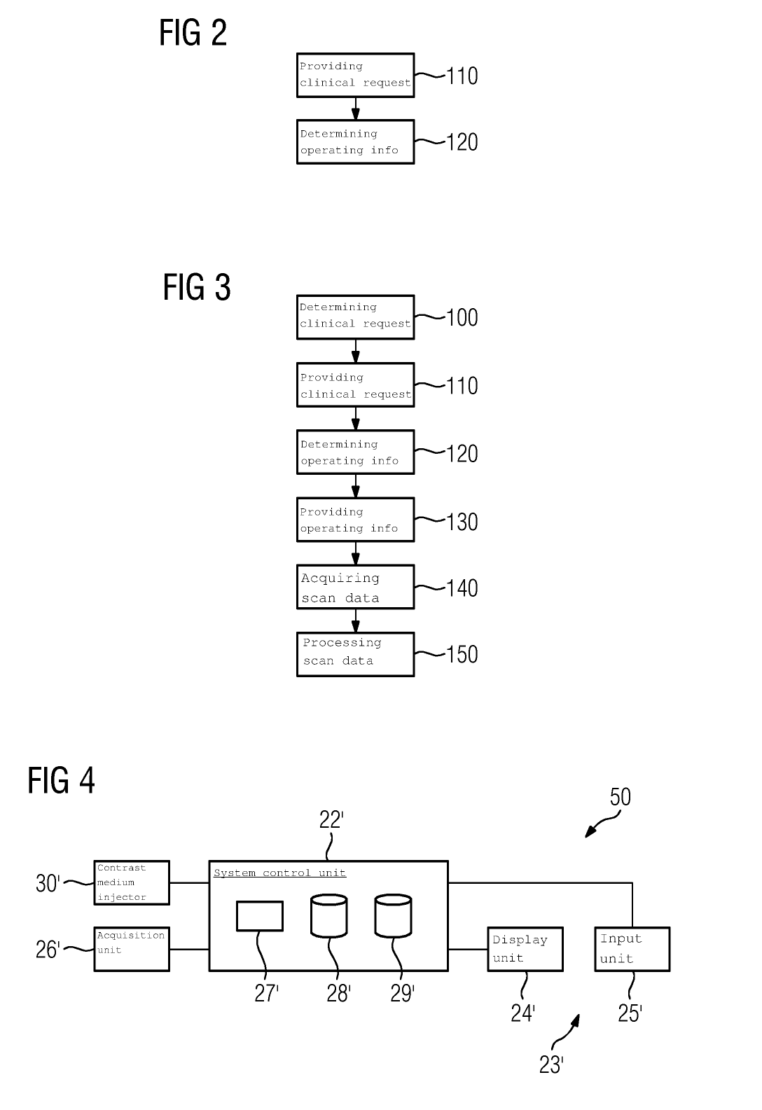

The magnetic resonance device 10 is configured together with the system control unit 22 for execution of a method for operation of a medical imaging device, as illustrated schematically in FIG. 2 and/or FIG. 3. For this purpose, the system control unit 22 has a computer unit 27 for determining an item of operating information on the basis of a clinical request that has been provided. The clinical request may be derived from a requisition that may be fed to the system control unit 22 by an acquisition unit 26, for example a scanner and/or a reading device and/or a camera. The system control unit 22 also includes a request database 28 and an operating information database 29. Determination of the clinical request may include a comparison of the requisition with the request database 28 and the determination of the operating information may include a comparison of the clinical request with the operating information database 29.

Furthermore, the system control unit 22 includes a suitable software unit and/or computer programs that may be loaded into a memory store of the system control unit 22, having program means in order to carry out the method for operation of a medical imaging device when the program is carried out in the system control unit 22 of the magnetic resonance device 10.

FIG. 2 depicts a method for operation of a medical imaging device. In act 110, the clinical request is provided, for example, as the standard diagnosis ICD-10 code 31.0. As depicted in FIG. 3, in a possible act 100, the clinical request may be determined from a requisition. An exemplary requisition may be, for example, a referral text “Exclude frontotemporal dementia” that is provided in paper form. By the acquisition unit 26, e.g., a scanner with a text recognition program, and a comparison with the request database 28, this text information may be converted into the aforementioned standard diagnosis ICD-10 code 31.0. It is also conceivable for image information to be used as the basis of a requisition.

On the basis of the clinical request provided, in act 120, operating information is determined for the medical imaging device. This may take place with the aid of a comparison with the operating information database 29. This determination may take place depending on at least one secondary parameter, for example, the country and/or medical specialism of a referrer and/or patient data. Thus, inter alia, any expectations of an initiator of the imaging examination, in particular the referrer, may be taken into account according to country and depending on the referring specialism. For example, oncologists often expect evidence-based results, as far as possible and may be reduced to yes/no statements, whereas orthopedics specialists and surgeons may be more interested in three-dimensional representations, while cardiologists require indication-dependent sections of the heart.

If the clinical request originates, in a first example, from a neurologist in the United States, then in this illustrative example, this may mean that a focus on morphological T1 and T2 contrast with an enlargement of the frontal region is desired. In a second example, for a psychiatrist from Germany, given the same clinical request, specifically the diagnostic ICD-10 code 31.0, a morphological representation with a clarification of the contrasts as a legend and a perfusion image with clarification of the blood flow values may be more useful.

Herein the country, in the two examples given USA or Germany, and the specialism of the referrer, in these cases neurologist or psychiatrist, are secondary parameters. Dependent thereon, the determination of the operating information may take place. Thus in the first example, a pulse sequence that records T1 and T2-weighted images may be determined as the scan parameter. Furthermore, as processing information, a selection and a scaling of one or more images to be created may be determined in that here the frontal region is selected and is to be represented in an enlarged scaling. In the second example, one or more scan protocols suitable for diffusion and/or perfusion measurement may be an item of operating information to be determined. The processing instruction determined also contains, in this example, stipulations for additional information to be presented, specifically that the figure to be generated may contain an explanatory legend. Explanatory labels and legends for images may simplify understanding of the data by the referrer and promote acceptance of the imaging examination.

The operating information may thus includes one or more scan parameters, for example a standard magnetic resonance protocol. In order to determine this scan parameter, for example in a table stored, for example, in the operating information database 29, this magnetic resonance standard protocol may be selected from a plurality of scan protocols.

It is also conceivable that the operating information includes at least one application parameter such as, for example, a property of a possible contrast medium and/or a dosage of the contrast medium and/or an influx speed of the contrast medium and/or an administration time point of the contrast medium. The determination of the at least one application parameter from the clinical request and any secondary parameters such as patient-specific features may be carried out, for example, on the basis of the operating information database in which data from the specialist literature and/or from a manufacturer of the contrast medium is stored. Following the determination of these application parameters, this information may be transferred to the contrast medium injector 30 where an injection is prepared, if required.

Furthermore, on the basis of the processing instruction determined as a further possible part of the operating information, a report to be created for the respective referrer may be optimized. Advantageously, herein, based on the clinical request and/or secondary parameters, for example determinable from a referral, results of the imaging examination are compiled, particularly sorted and labeled according to importance. By this means referrer-specific diagnostic preferences may be taken into account. Further conceivable additional information to be displayed is, for example, quantitative clinical scores such as PI-RADS (Prostate Imaging-Reporting and Data System) for a prostate finding or BI-RADS (Breast Imaging-Reporting and Data System) for a breast finding.

It is further depicted in FIG. 3 that following the determination of the operating information in act 120, in an optional further act 130, at least part of the operating information is provided to the operator by an output unit, for example the display unit 24. This may be changed by the operator if needed, for instance by the input unit 25. The operator may thus start the imaging scan process directly or may still configure any scan protocol before the scanning process, in particular one automatically proposed to him. Naturally a termination of the method is also possible at this act.

In the possible at least partial provision and adaptation of the operating information in act 130, in addition, body regions may be determined by graphical selection of an acquisition region and acquisition times by graphical input of times of day.

In a more automated form, it is conceivable that a radiologist or even the patient himself starts the scan procedure. In this case, a conventional MTA is no longer needed as the operator, so that any personnel may concentrate on patient care, for example, in the case of MRT, carrying out the coil positioning and/or intervening in case of emergencies. This is advantageous, above all, for regions of the world in which specialist medical personnel, for example MTAs, are scarce.

In act 140, on the basis of the at least one scan parameter determined, scan data is acquired by the medical imaging device. During or before the scan data acquisition, it is conceivable that on the basis of the at least one application parameter, a contrast medium is administered via the contrast medium injector 30 or via a contrast medium administration unit 50 depicted in FIG. 4. This may take place either fully automatically without the operator needing to make further input or after prior confirmation by the user in act 130. Herein, for example, a signal may be transmitted from the system control unit 22 to the contrast medium injector 30 so that the contrast medium injector 30 starts the contrast medium administration as intended.

In act 150, the acquired scan data is processed on the basis of the processing instruction. As a result, for example, the referrer as the client of the radiologist receives a processing of the results according to need that is oriented to his preferences and guidelines. Through a better explanation of the image content, the acceptance and informativeness of the imaging data may also be increased, e.g., understanding of the diagnostic results may be enhanced. In particular, newer methods, for example MR diffusion or CT tumor perfusion, may be specifically prepared and communicated in the oncology department.

FIG. 4 depicts a contrast medium administration unit that includes a contrast medium injector 30′ and a computer unit 27′ for determining an item of operating information, in particular at least one application parameter on the basis of a clinical request provided. Optionally, it also includes an acquisition unit 26′ for providing a requisition by acquiring an item of text and/or image information. In addition to the computer unit 27′, the system control unit 22′ includes an optional request database 28′ for determining the clinical request by a comparison of the requisition and an operating information database 29′ for determining the operating information by a comparison of the clinical request.

Furthermore, by a possible user interface 23′ connected to the system control unit 22′ and includes a display unit 24′ and an input unit 25′, data is input and output, for example, for the monitoring and/or correction of the at least one application parameter, such as the property of a contrast medium and/or a dosage of the contrast medium and/or an inflow velocity of the contrast medium and/or an administration time point of the contrast medium.

In summary, the embodiments relate to a method for operation of a medical imaging device and to a medical imaging device and a computer program product. According to the method, a clinical request is provided, on the basis of which operating information is determined for the medical imaging device by a computer unit. An indication-driven at least partially automated conversion of information is proposed, in particular a conversion of referral requests into an imaging procedure, and conversely, an adaptation of the imaging results to expectations of the referrer.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for operation of a medical imaging device, the method comprising:
providing a clinical request; and
determining, by a computer unit, an item of operating information for the medical imaging device based on the clinical request provided.

2. The method of claim 1, further comprising:
ascertaining the clinical request based on a requisition.

3. The method of claim 2, wherein a provision of the requisition comprises acquiring an item of text, image information, or both the text and the image information by an acquisition unit.

4. The method of claim 2, wherein the determining of the clinical request comprises comparing the requisition with a request database.

5. The method of claim 1, wherein the operating information comprises at least one scan parameter.

6. The method of claim 5, further comprising:
acquiring scan data, by the medical imaging device, based on the at least one scan parameter.

7. The method of claim 5, wherein, in order to determine the at least one scan parameter, one scan protocol is selected from a plurality of scan protocols.

8. The method of claim 5, wherein the operating information further comprises at least one application parameter.

9. The method of claim 8, wherein the at least one application parameter is one or more of a property, a dosing, an influx speed, or an administration time point of a contrast medium.

10. The method of claim 1, wherein the determining of the operating information comprises comparing the clinical request with an operating information database.

11. The method of claim 1, wherein the determining of the operating information takes place dependent on at least one secondary parameter.

12. The method of claim 1, further comprising:
providing at least one part of the operating information to an operator by an output unit.

13. The method of claim 12, wherein the operating information provided to the operator is altered by the operator by an input unit.

14. The method of claim 1, wherein the operating information comprises a processing instruction.

15. The method of claim 14, wherein the processing instruction comprises stipulations for a selection, scaling, or both the selection and the scaling of one or more images to be created.

16. The method of claim 14, wherein the processing instruction further comprises stipulations on additional information to be displayed of the one or more images to be created.

17. The method of claim 14, further comprising:
acquiring scan data, by the medical imaging device, based on at least one scan parameter of the operating information; and
processing the acquired scan data is processed in accordance with the processing instruction.

18. A medical imaging device comprising:
a computer unit, wherein the medical imaging device is configured to:
provide a clinical request; and
determine, by the computer unit, an item of operating information for the medical imaging device based on the clinical request provided.

19. The medical imaging device of claim 18, further comprising:
a contrast medium injector or an interface to the contrast medium injector,
wherein the operating information comprises at least one application parameter, the at least one application parameter being one or more of a property, a dosing, an influx speed, or an administration time point of a contrast medium of the contrast medium injector.

20. A contrast medium administration unit comprising:
a contrast medium injector; and
a computer unit for determining an item of operating information based on a clinical request provided.

21. A computer program product comprising:
a computer program code for one or more programs,
wherein the computer program product is directly loadable into a memory store of a programmable system control unit of a medical imaging device, and
wherein the computer program code is configured to, with at least one processor, cause the medical imaging device to at least perform:
provide a clinical request; and
determine an item of operating information for the medical imaging device based on the clinical request provided.
